(19) United States
(12) Patent Application Publication
(10) Pub. No.: US 2007/0152967 A1
(43) Pub. Date: Jul. 5, 2007

(54) Waterproof and impact resistant mouse

(75) Inventor: Guan Wei Ping, Shenzhen (CN)

Correspondence Address: STORM LLP, BANK OF AMERICA PLAZA, 901 MAIN STREET, SUITE 7100, DALLAS, TX, 75202, US

(73) Assignee: Dobbs-Stanford Corporation

(21) Appl. No.: 11/474,539

(22) Filed: Jun. 26, 2006

(30) Foreign Application Priority Data
Jan. 1, 2006 (CN) 200620032715.6

(51) Int. Cl. G09G 5/08

(52) U.S. Cl. 345/163

(57) ABSTRACT

A waterproof and impact resistant mouse is provided. The mouse comprises a body case, an electronic device included in the chamber of the body case, operable units which are left and right keys in the front part of the body case, and three scroll keys (3) in a tandem arrangement between the left and right keys. The upper body case and the lower body case are made of silicone and fixed as an integral formation. A rigid extra layer is adhered to the surface under the keys. The integral formation structure of the body case and the keys ensures that the mouse is waterproof. Also, because the opening for the outgoing wire, the mouse wire, and the transparent hole are sealed, this mouse is substantially airtight and waterproof. Additionally, its resistance to impact is extremely strong; therefore, even if the mouse is thrown forcefully on the ground, it will spring up like a ball.

### CLAIM OF PRIORITY

This application claims priority from Chinese Patent Application No. 200620032715.6 entitled “THE WATERPROOF AND IMPACT RESISTANT MOUSE” filed on behalf of Guan Wei Ping on Jan. 1, 2006.

### TECHNICAL FIELD

This invention relates to a computer mouse, and more particularly to a waterproof and impact resistant mouse.

### BACKGROUND OF THE INVENTION

The outer body cases of computer mice available now are usually made of rigid material, such as rigid plastics. These rigid outer body cases cannot produce a cushioning effect, so the outer body case and the internal electronic devices can be damaged when the mouse is knocked or impacted. Moreover, since the operable units on the outer body case are also made of rigid material, they cannot be elastically deformed in operation. The operable units should be in a discrete structure with the outer body case, otherwise, the operable units cannot work. Because there is still a narrow gap between the body case and the operable units in the discrete structure, this kind of mouse is not waterproof.

The Chinese utility model patent right, Ser. No. CN2,736,854, discloses a soft case mouse which is filled with elastic material. This mouse is designed in conformance with human physiology in order that the user's hand will not suspend and the tension of the fingers, palm, wrist and arm will be reduced by making the whole palm touch the mouse sufficiently. In this case, the arm of the user's hand will be relaxed, and associated diseases or sufferings of the hand will be avoided. Though this mouse has resistance to impact to some extent, it is not waterproof owing to its discrete structure.

Therefore, there is a need for a computer mouse that is both waterproof and impact resistant that at least addresses some of the problems associated with conventional computer mice.

### SUMMARY OF THE INVENTION

This invention discloses a mouse which is waterproof and impact resistant.

The mouse of the present invention is similar to the existing ones in that it includes a body case, internal electronic devices and operable units on the body case. The mouse of the present invention is different in that both the operable units and the body case are made of silicone, which forms an integral formation structure. Because the body case and the operable units of the new mouse are made of silicone and merged into a sealed integral formation, the new mouse is both waterproof and impact resistant. Furthermore, the body case and the operable units can be deformed in operation, especially when the keys are pressed, yet the operation will not be affected because the keys, body case, and joints are elastic deformable.

The general configuration of the mouse of the present invention includes both new features and more conventional features. The mouse of the present invention is also comprised of an upper case and a lower case (of which one or both are made of silicone), where the upper and lower cases are sealed as an integral formation. As with conventional mice, left and right keys are installed on the front of the upper case. However, no roller wheel is installed between these operable units. Instead, additional scroll keys are installed between the left and right keys, wherein the number of keys can be arbitrarily chosen. Generally, though, three keys are used. Preferably, a technical assembly vent is made in both the upper and lower cases in order to drain out the air inside. However, for the sake of aesthetic perception, the assembly vent can be located in the lower case only. Also, for the purpose of forming an airtight mouse, a cork can be used.

Within the integral formation structure are electronic components or devices. The electronic devices inside the mouse, such as the electronic key-presses, protrude the case. The key-presses are generally not convenient to install because one end is usually salient or convex. Therefore, a concave member should be made in order to hold the convex electronic key-presses. Since the key-presses are elastically deformable, greater pressure is typically needed to operate them. Therefore, the concave member should include an additional, more rigid layer or member.

Additionally, this mouse can be made as a typical track ball mouse or an optical mouse. Preferably, though, the mouse of the present invention is best adapted for an optical mouse. With the optical mouse, a transparent hole should be formed in the lower case that is adapted to receive a lens. To prevent water from entering, the lens and the lower case should be adhered to the integral formation. A slide block should also be included near the transparent hole on the bottom of the lower case to reduce the friction between the mouse and the desk surface.

The mouse of the present invention can also be a wireless mouse. As a wireless mouse, the body case is separated into two chambers by a septum. One chamber is airtight and contains electronic devices or components. The other chamber contains batteries. For the chamber containing batteries, there must be an opening, on which a removable cover is fixed, so that batteries can be changed when necessary. The cover should also fit so as to ensure that the battery chamber is substantially airtight, so the mouse remains waterproof.

The integral formation structure of the body case and the keys guarantees that the mouse is both waterproof and impact resistant. The resistance to impact is extremely strong, and, even if the mouse is thrown forcefully on the ground, it will spring up like a ball.

### BRIEF DESCRIPTION OF THE DRAWINGS

Features and advantages of embodiments of the claimed subject matter will become apparent as the following detailed description proceeds, and upon reference to the figures, where like numerals depict like parts, and in which:

FIG. 1 is a cross-sectional side view of the mouse in accordance with a preferred embodiment of the present invention;

FIG. 2a is a top view of the upper case of the embodiment disclosed in FIG. 1;

FIG. 2b is a bottom view of the embodiment disclosed in FIG. 2a;

FIG. 3 is a side-sectional view of the embodiment disclosed in FIG. 2a;

FIG. 4a is a block diagram of the lower case of the embodiment disclosed in FIG. 1;

FIG. 4b is a bottom view of the embodiment disclosed in FIG. 4a;

FIG. 4c is a side-sectional view of the embodiment disclosed in FIG. 4a; and

FIG. 5 is a side-sectional view of another preferred embodiment of the present invention.

### DETAILED DESCRIPTION

Refer now to the drawings wherein depicted elements are, for the sake of clarity, not necessarily shown to scale and wherein like or similar elements are designated by the same reference numeral through the several views.

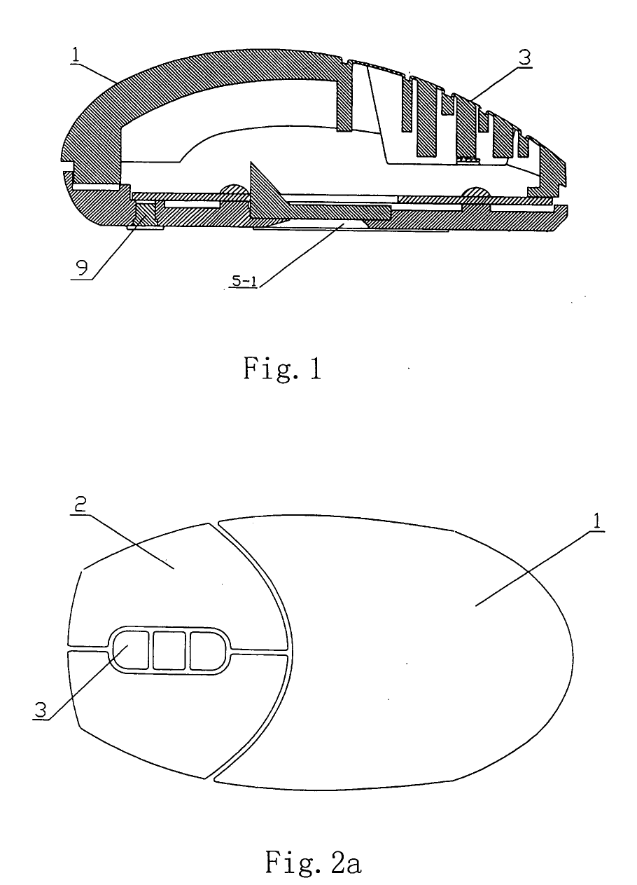

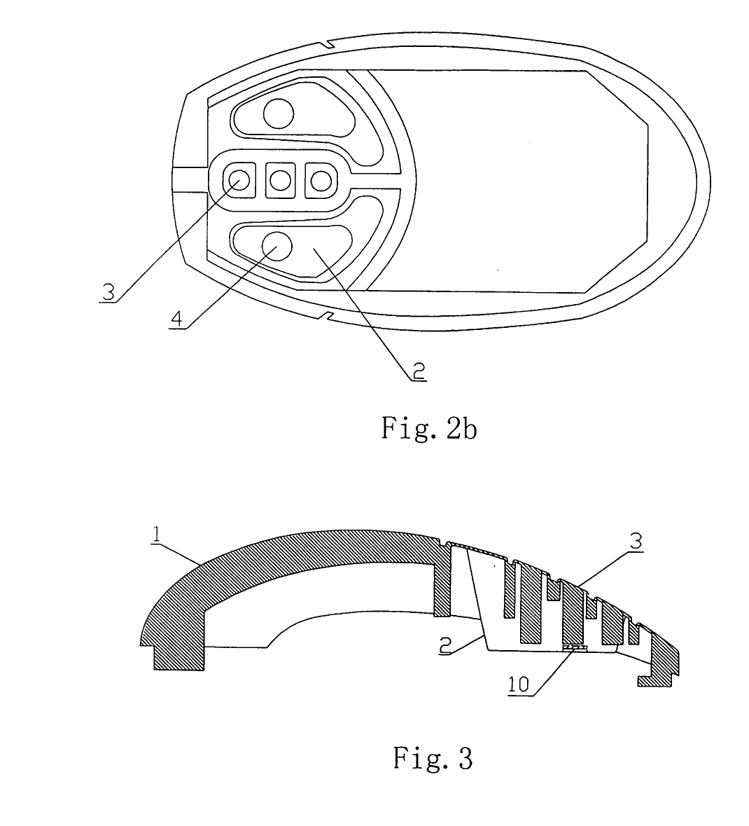

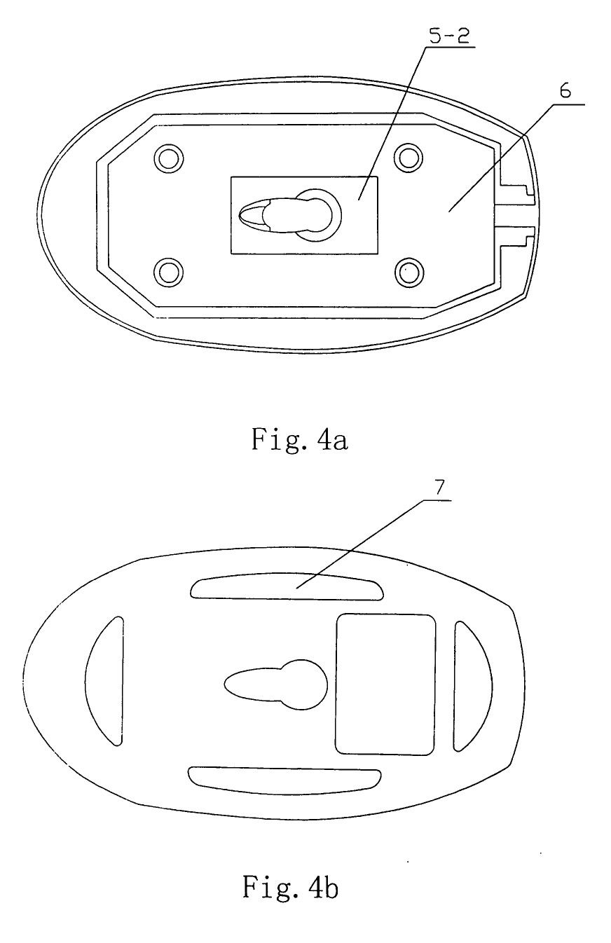

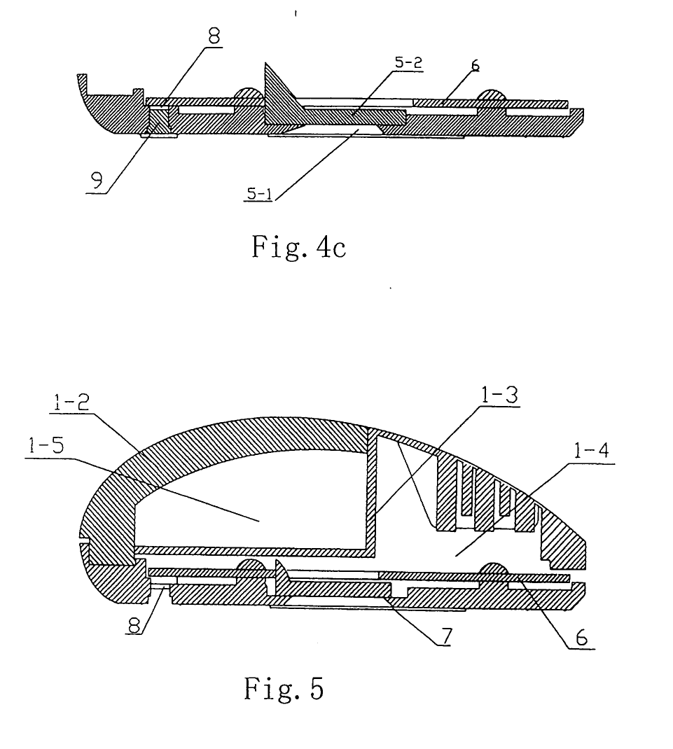

The structure in FIGS. 1-4 is the typical embodiment for the waterproof and impact-resistant mouse. The mouse is comprised of an upper case 1, a lower case 5, and electronic device 6. Electronic device 6 is installed inside a chamber of the case formed between upper case 1 and lower case 5. In the front part of the case, there is an opening for an outgoing wire, through which a mouse wire (not shown) extends. The mouse wire (not shown) and the opening are sealed by a bonding agent, while the key-presses and upper case 1 are made of silicone as an integral formation. Lower case 5 is also made of silicone and is secured to upper case 1.

In the front end of upper case 1, left and right keys 2 are set, and in between the left and right keys 2, three additional scroll keys 3 are included in a tandem arrangement. Under left and right keys 2 are concave members 4 to which an extra rigid layer 10 is adhered.

In this embodiment, the mouse is an optical mouse. A transparent hole 5-1 is formed in lower case 5, which is covered by a lens 5-2. Lens 5-2 is also adhered to lower case 5. Additionally, a technical assembly vent 8 is formed in lower case 5, in which there is also a cork 9 where the vent 8 and cork 9 are sealed with a bonding agent. Because lower case 5 is made of silicone (which has a relatively high coefficient of friction), a slide block 7 is secured to lower case 5 to reduce friction.

FIG. 5 is a side-sectional view of the wireless mouse in accordance with another typical embodiment of the present invention. In this embodiment, upper case 1 is composed of the front part or section 1-1 and the rear part or section 1-2 of upper case 1. In the back end of section 1-1 of upper case 1 is a septum 1-3. Section 1-1 and septum 1-3 are secured to lower case 5 as an integral formation. In between section 1-1, septum 1-3, and lower case 5, an airtight chamber 1-4 is formed, in which the electronic device 6 is located. The rear part or section 1-2 of upper case 1 is also a removable cover, and in between the removable cover 1-2 and the septum 1-3 is a battery chamber 1-5.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

What is claimed is:

1. A waterproof and impact resistant mouse comprising:
a silicone upper case;
a left key and a right key formed on the upper case;
a plurality of scroll keys formed on the upper case between the left and right keys;
a silicone lower case secured to the upper case to form a sealed enclosure;
a cavity formed within the enclosure;
a septum dividing the cavity into a battery chamber and an electronics chamber;
operable mouse electronics located in the electronics chamber;
a removable rear portion of the enclosure for access to the battery chamber; and
the electronics chamber being a waterproof chamber.

2. The mouse of claim 1, further comprising:
a concave member located beneath each key;
a rigid member adhered to each concave member;
wherein the mouse electronics are adapted to receive signals from the rigid members beneath the keys.

3. The mouse of claim 1, further comprising:
a hole in the lower case; and
a lens coving the hole.

4. The mouse of claim 1, further comprising:
a slide block secured to the lower case.

5. The mouse of claim 1, further comprising:
a mouse wire opening in the enclosure;
a mouse wire electrically connected to the mouse electronics, and extending through the wire opening; and
a bonding agent sealing the mouse wire within the wire opening.

6. The mouse of claim 1, further comprising:
a vent extending through the enclosure.

7. The mouse of claim 6, further comprising:
a plug located in the vent.

8. A waterproof and impact resistant mouse comprising:
a silicone upper case;
a left key and a right key formed on the upper case;
a plurality of scroll keys formed on the upper case between the left and right keys;
a concave member located beneath each key;
a rigid member adhered to each concave member;
a silicone lower case secured to the upper case to form a sealed enclosure;
a cavity formed within the enclosure;
operable mouse electronics located in the cavity; and
wherein the mouse electronics are adapted to receive signals from the rigid members beneath the keys.

9. The mouse of claim 8, further comprising:
a septum dividing the cavity into a battery chamber and an electronics chamber;
the mouse electronics being located in the electronics chamber;
a removable rear portion of the enclosure for access to the battery chamber; and
the electronics chamber being a waterproof chamber.

10. A waterproof and impact resistant mouse comprising:
a silicone upper case;
a left key and a right key formed on the upper case;
a plurality of scroll keys formed on the upper case between the left and right keys;
a concave member located beneath each key;
a rigid member adhered to each concave member;
a silicone lower case secured to the upper case to form a sealed enclosure;
a cavity formed within the enclosure;
a septum dividing the cavity into a battery chamber and an electronics chamber;
operable mouse electronics located in the electronics chamber;
a removable rear portion of the enclosure for access to the battery chamber;
the electronics chamber being a waterproof sealed chamber; and
wherein the mouse electronics are adapted to receive signals from the rigid members beneath the keys.

11. The mouse of claim 10, further comprising:
a hole in the lower case; and
a lens coving the hole.

12. The mouse of claim 10, further comprising:
a slide block secured to the lower case.

13. The mouse of claim 10, further comprising:
a mouse wire opening in the enclosure;
a mouse wire electrically connected to the mouse electronics, and extending through the wire opening; and
a bonding agent sealing the mouse wire within the wire opening.

14. The mouse of claim 10, further comprising:
a vent extending through the enclosure.

15. The mouse of claim 14, further comprising:
a plug located in the vent.
